(19) United States
(12) Patent Application Publication
(10) Pub. No.: US 2026/0356122 A1
(43) Pub. Date: Nov. 12, 2026

(54) WHEEL INCLUDING INDEPENDENTLY ROTATABLE HUBS AND SHAPE-ADAPTABLE RIM

(71) Applicant: EIDON, LLC, Mercer Island, WA (US)

(72) Inventor: Roger N. Johnson, Mercer Island, WA (US)

(21) Appl. No.: 19/123,344

(22) PCT Filed: Oct. 26, 2023
(86) PCT No.: PCT/US2023/077927

§ 371 Date: Apr. 22, 2025

Related U.S. Application Data
(60) Provisional application No. 63/420,050, filed on Oct. 27, 2022.

(51) Int. Cl. B60B 1/14; B60B 9/00; B60B 19/00; B60B 25/02; B62K 25/04

(52) U.S. Cl. CPC B60B 1/14; B60B 9/005; B60B 19/00; B60B 25/02; B62K 25/04

(57) ABSTRACT

A wheel includes at least two hubs along an axis of rotation of the wheel; a shape-adaptable rim; and a plurality of rigid struts extending outward from the hubs to the rim. Each hub is independently rotatable about the axis. Each strut has a first end pivotably connected to one of the hubs and a second end pivotably connected to the rim.

### CROSS-REFERENCE TO RELATED APPLICATIONS

The present application claims the benefit of priority to U.S. Provisional Application No. 63/420,050 , filed on Oct. 27, 2022, the contents of which are incorporated herein by reference.

### BACKGROUND

Pneumatic tires are used for a wide variety of ground vehicles, such as wheelchairs, bicycles, automobiles, and trucks. A pneumatic tire absorbs an impact between vehicle and road. For instance, when a vehicle transits over a bump in a road, the pneumatic tire deforms to limit vertical travel. Vehicles may be equipped with springs that limit the vertical travel when transiting larger bumps, and shocks absorbers that dampen this movement for better recovery after large bumps.

Pneumatic tires have certain drawbacks: a pneumatic tire can leak after being punctured by a sharp object, tire pressure must be maintained, and a pneumatic tire must be replaced after its tread wears below a certain level.

Many attempts have been made to replace the pneumatic feature of localized compliant suspension between a rigid rim and its contact point with the ground.

### SUMMARY

According to one embodiment, a wheel includes at least two hubs along an axis of rotation of the wheel; a shape-adaptable rim; and a plurality of rigid struts extending outward from the hubs to the rim. Each hub is independently rotatable about the axis. Each strut has a first end pivotably connected to one of the hubs and a second end pivotably connected to the rim.

### BRIEF DESCRIPTION OF THE DRAWINGS

Reference will now be made to the attached drawings, when read in combination with the following specification, wherein like reference numerals refer to like parts throughout the several views, and in which:

FIG. 1A is an illustration of a wheel including independent hubs and a flexible rim, according to a first embodiment.

FIG. 1B is an illustration is illustration of a hub and strut of the wheel of FIG. 1A.

FIGS. 2A, 2B and 2C are illustrations of different shapes of the rim during operation of the wheel of FIG. 1A.

FIG. 3 is an illustration of an attachment bracket on the rim.

FIG. 4 is an illustration of a wheel including independent hubs and a flexible rim, according to a second embodiment.

FIG. 5 is an illustration of a wheel including independent hubs and a flexible rim, according to a third embodiment.

FIGS. 6A, 6B and 6C are illustrations of different shapes of the rim during operation of the wheel of FIG. 5.

FIG. 7 is an illustration comparing rim shapes for different node designs.

FIGS. 8A, 8B, 9 and 10 are illustrations of a wheel including independent hubs and a segmented rim, according to a fourth embodiment, where FIG. 10 illustrates partially removed portions of a first hub and a strut.

FIG. 11 is an illustration of a joint formed by adjacent rim segments and a strut of the wheel of FIG. 10.

FIG. 12 is a block illustration of a vehicle, according to a first embodiment.

FIG. 13 is an illustration of an automotive suspension, according to a first embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

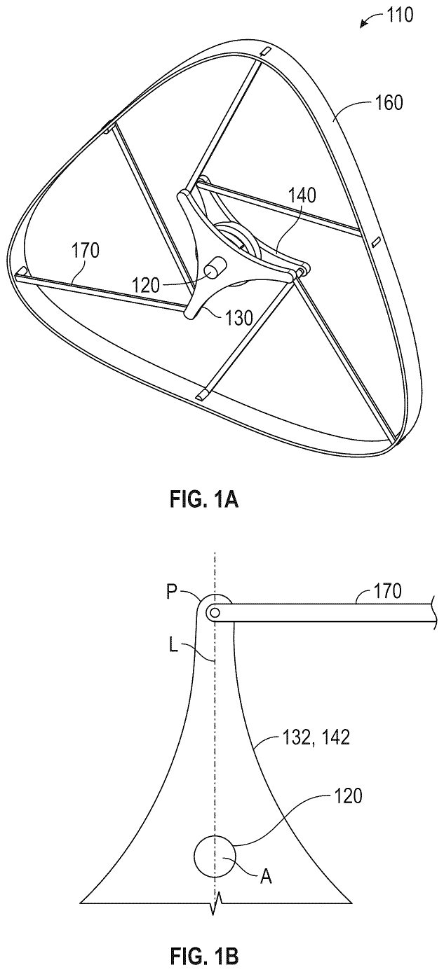

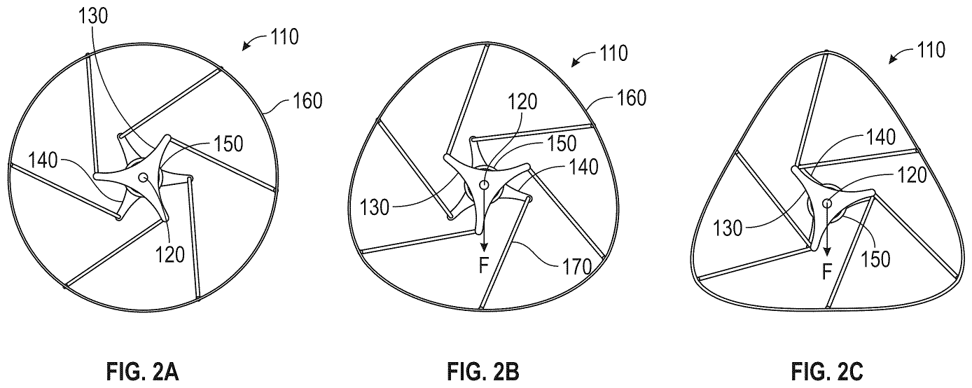

Reference is made to FIG. 1A. A wheel 110 includes an axle 120, which defines an axis of rotation and a plane of rotation (the axis is normal to the plane). The wheel 110 further includes first and second hubs 130 and 140 that are spaced apart along the axle 120. Each hub 130 and 140 is configured to be independently rotatable about the axle 120 and, therefore, about the axis of rotation. For example, bearings may be used to allow rotation of the hubs 130 and 140 relative to the axle 120.

In the embodiment illustrated in FIG. 1A, each hub 130 and 140 has a central portion and arms extending radially outward from the central portion.

For each hub 130 and 140, the arms are equi-angularly spaced about the central portion (that is, by 120 degrees).

A torsion spring 150 is coupled between the first and second hubs 130 and 140. The axle 120 extends through the torsion spring 150. A first end of the torsion spring 150 is secured to the first hub 130, and a second end of the torsion spring 150 is secured to the second hub 140. For example, the torsion spring 150 may have spring stops that are located within openings in the hubs 130 and 140. The torsion spring 150 acts to resist coiling and uncoiling forces and, in so doing, resists the forces that rotate the hubs 130 and 140 relative to each other. When coiled, the torsion spring 150 stores mechanical energy.

The wheel 110 further includes a rim 160 that lies in the plane of rotation. The rim 160 is continuous and flexible. Flexibility may be achieved by choice of material and wall thickness. As described below, the flexible rim 160 should be able to deform during operation without breaking, stay in its plane of rotation, and not absorb excessive energy while changing shape.

The wheel 110 further includes a plurality of elongated, rigid struts 170 extending between the hubs 130 and 140 to the rim 160. The struts 170 are designed for tension and compression. Each strut 170 has a first end that is pivotably connected to one of the arms of one of the hubs 130 or 140 and a second end that is pivotably connected to the rim 160. Pivot axes at the attachments to the rim 160 and the hubs 130 and 140 are normal to the plane of rotation. The struts 170 transmit forces between the rim 160 and the hubs 130 and 140.

In the three node design illustrated in FIG. 1A, three struts 170 are pivotably connected to the first hub 130, and three struts 170 are pivotally connected to the second hub 140. The second ends of the struts 170 are equi-angularly spaced about the rim (that is, by 60 degrees). All six struts 170 are of equal length.

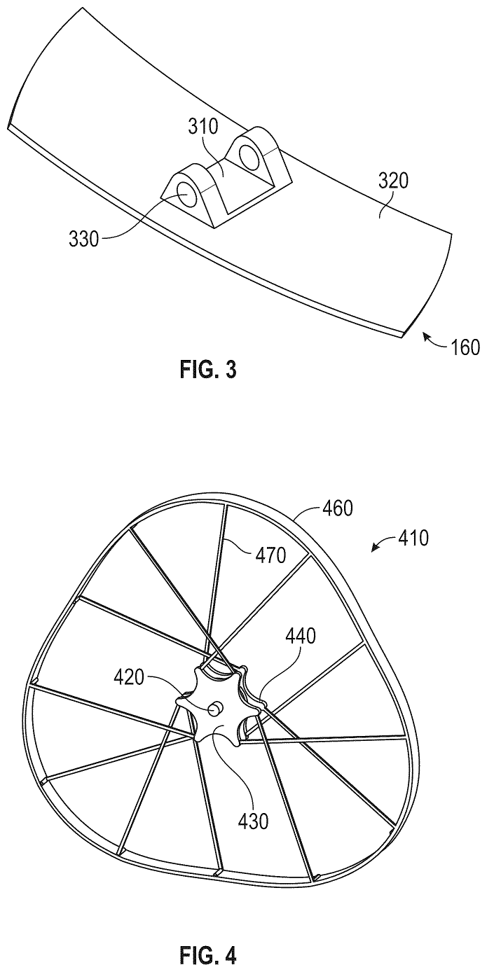

FIGS. 2A, 2B and 2C illustrate different shapes of the wheel 110. As used herein, operational loading includes a downward force on the hubs 130 and 140 towards the ground. The operational loading may be applied, for instance, via the axle 120. For instance, the axle 120 might bear the weight of a vehicle.

FIG. 2A shows the wheel 110 in an undisturbed state, with no operational load applied to the hubs 130 and 140, and no forces that cause rotation of the hubs 130 and 140 and the rim 160 about the axle 120. With additional reference to FIG. 1B, each strut 170 is roughly perpendicular to its associated arm 132, 142. For a line L that extends radially from the axis A of rotation (defined by the axle 120) through the pivot axis P at the first end of the strut 170, the strut 170 is roughly normal to the line L.

The hubs 130 and 140 are angularly offset. The arms of the first hub 130 are angularly spaced from the arms of the second hub 140 (that is, by 60 degrees). As such, the rim 160 has a circular shape.

At least one pivot is off-center on each hub 130 and 140. When operational loading F is applied to the hubs 130 and 140, the hubs 130 and 140 are forced to counter-rotate. The shape of the rim 160 begins to change, transitioning from the shape shown in FIG. 2A, to the shape shown in FIG. 2B and then to the shape shown in FIG. 2C.

FIG. 2B shows that, during counter-rotation, the arms of the first hub 130 move closer to alignment with the arms of the second hub 140. The torsion spring 150 resists this counter-rotation and stores mechanical energy.

The struts 170 transmit forces to the rim 160 that cause the rim 160 to deform.

The struts 170 connected to the first hub 130 push on the rim 160, while the struts 170 connected to the second hub 140 pull on the rim 160. The shape of the rim 160 is no longer circular.

FIG. 2C shows that the arms of the hubs 130 and 140 are now aligned, and the rim 160 has been adapted to a rounded polygonal shape in general and a rounded triangular shape in particular. The rounded triangular shape has three nodes. The rim 160 now has a relatively flat contact patch on the ground.

If the operational loading is removed from the axle 120, the torsion spring 150 forces the hubs 130 and 140 and struts 170 back to the positions of FIG. 2A, returning the rim to the circular shape of FIG. 2A.

As the rim 160 is rotated, different struts 170 maintain the rounded triangular shape. Thus, as the wheel 110 is moved along the ground, different portions of the rim 160 come into contact with the ground, but the rim 160 maintains its rounded triangular shape and its contact patch. If the force F remains constant and the rim does not encounter any disturbances (e.g., bumps), the rounded triangular shape does not change. In effect, a rolling flat spot is achieved.

The rim 160 deforms upon impact or pressure against a floor, wall, or curb in whatever direction it occurs with varying suspension force and shock absorption. The torsion spring 150 provides a restoring force that replaces the air pressure “spring” of a pneumatic tire. The torsion spring 150 allows the hubs 130 and 140 to move and enables deformation of the rim 160 to surmount small bumps without forcing the axle 120 to rise.

The rolling flat spot of the rim 160 provides substantially greater ground contact than conventional wheels and pneumatic tires, thereby improving transit over unimproved surfaces. The shape of the rim 160 changes without modifying the surface length. The rim 160 does not require an ideal circular shape.

Operational loading can reduce the height of the axle 120 by ten to forty percent. This provides an additional suspension effect.

The wheel 110 eliminates the need for a pneumatic tire. The elimination of pneumatic items makes the wheel 110 lighter, stronger, puncture proof and much simpler to manufacture.

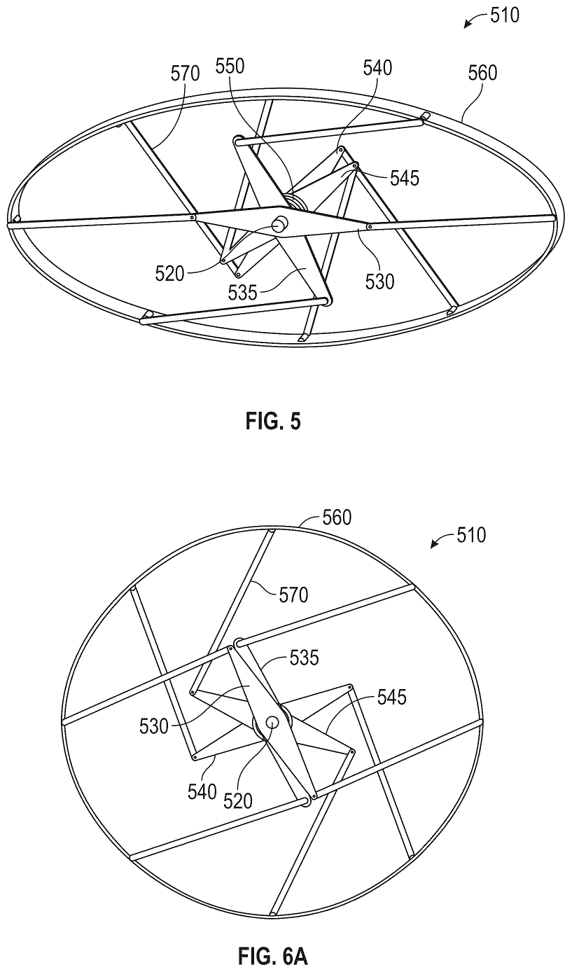

A wheel herein is not limited to the embodiment of FIG. 1A. The struts 170 may be attached to the rim 160 in a variety of ways. FIG. 3 shows an example in which a bracket 310 is affixed to (e.g., spot welded) or formed integrally with the inner surface 320 of the rim 160. A pin (not shown) is inserted through holes 330 in the bracket 310 and a pin hole at the second end of strut 170.

A wheel herein is not limited to six struts 170. The wheel of FIG. 1A may be modified by increasing the number of struts 170. A greater number of struts 170 would apply a more uniform force to the rim 160, and it would allow the wheel 110 to have a greater load-carrying capacity.

A greater number of struts would also benefit a wider rim. The additional struts may keep the rim from twisting too far out of the plane of rotation.

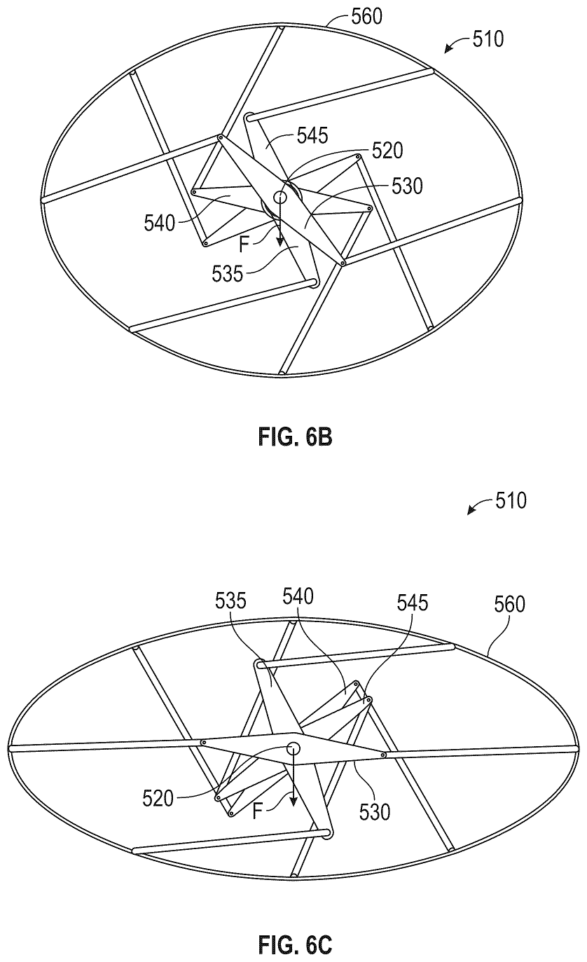

Reference is made to FIG. 4, which illustrates a three node wheel 410 having twelve struts 470. The first ends of six struts 470 are pivotably connected to the first hub 430, and the first ends of the other six struts 470 are pivotably connected to the second hub 440. The second ends of the struts 470 are pivotably connected to the rim 460 in alternating sequence (strut 470 from first hub 430, strut 470 from second hub 440, strut 470 from first hub 430, and so on). Angular spacing between the struts 470 at the rim 460 is 30 degrees. Angular spacing of the arms on each of the hubs 430 and 440 is 60 degrees.

Unlike the wheel 110 of FIG. 1A, the wheel 410 of FIG. 4 has struts 470 that cross. There is still one strut 470 per node, where each strut extends to the corners of the maximally deformed shape with maximum distance from the axle 420. The additional struts 470 cross to act in a way that minimizes the distance from the axle 420. The crossing struts 470 provide a way to push and pull on the rim 460 from the same hub 430, 440. For example, the first hub 430 may push a first group of struts attached to the rim nodes while the first hub simultaneously pulls a second group of struts attached to locations (e.g., halfway) between the nodes. In other words, employing crossing struts 470 provides a way to deform the rim 460 by both push and pull from the same hub 430, 440.

A wheel herein is not limited to a three node design. Other embodiments of a wheel herein may have two nodes or more than three nodes.

In general, fewer nodes enable a more extreme axle drop (which determines suspension limits). Increasing the number of nodes enables the number of struts per hub to be increased, which can increase load capacity and rim strength.

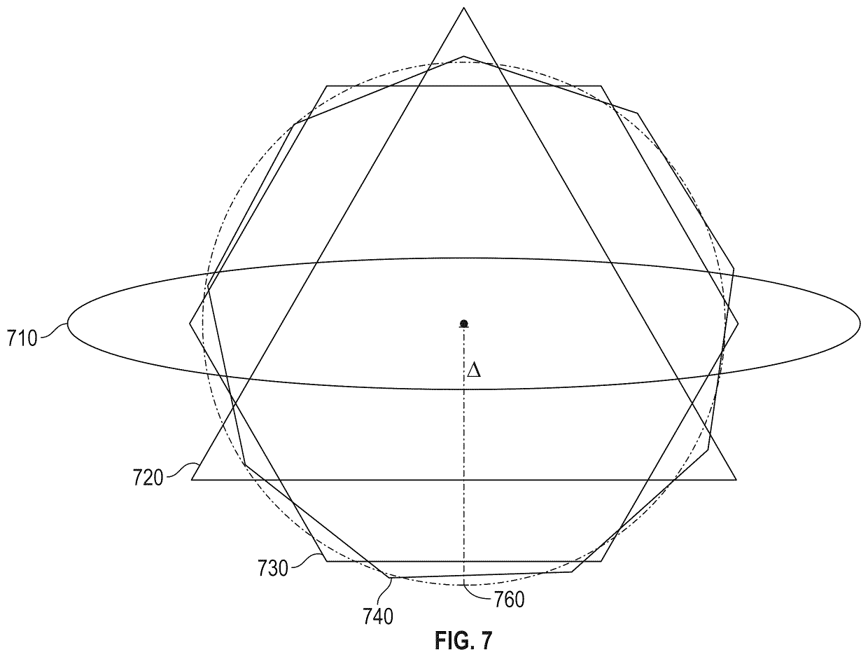

Reference is made to FIG. 5, which illustrates a wheel 510 having a two node design. Four hubs 530, 535, 545 and 540 are independently rotatable about an axle 520. Each hub 530, 535, 545 and 540 has two arms. The wheel 510 has eight struts 570. Each strut 570 has a first end pivotably connected to one of the arms, and a second end pivotably connected to the rim 560.

Inner hubs 535 and 545 are coupled by a torsion spring 550. If desired, suspension may be further increased by coupling a second torsion spring between hubs 535 and 530, and coupling a third torsion spring between hubs 540 and 545.

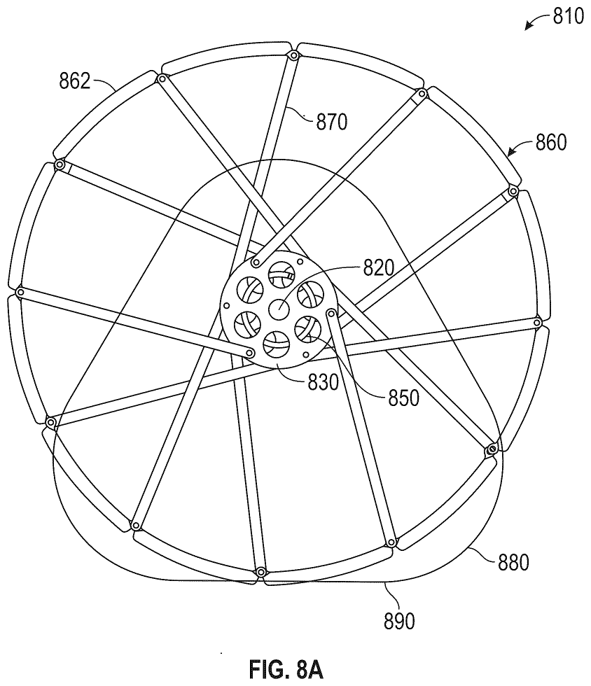

FIGS. 6A, 6B and 6C illustrate different shapes of the rim 560 during operation of the wheel 510. FIG. 6A shows the wheel 510 in an undisturbed state, with no downward force applied to the axle 520, and no forces that cause rotation of the hubs 530, 535, 540 and 545 and the rim 560 about the axle 520. Each strut 570 is roughly perpendicular to a line through the pivot point and the axis of rotation. The hubs 530 and 535 are nearly aligned. The hubs 540 and 545 are offset. As such, the rim 560 has a circular shape.

FIG. 6B shows the wheel 510 when a downward force F is applied to the axle 520. The hubs 530 and 535 counter-rotate out of alignment, and the hubs 545 and 540 counter-rotate towards alignment. Those struts 570 attached to the hub 530 push on the rim 560. Those struts 570 attached the other hubs 535, 540 and 545 begin to pull on the rim 560. As such, the rim 560 is slightly oval-shaped.

FIG. 6C shows the wheel 510 as the downward force F continues to be applied to the axle 520. The hubs 530 and 535 have counter-rotated out of alignment, and the hubs 540 and 545 have counter-rotated almost into alignment. As such the rim 560 has an elliptical shape, with a large contact patch on the ground. Maximum deformation for this design is about 40% of the radius.

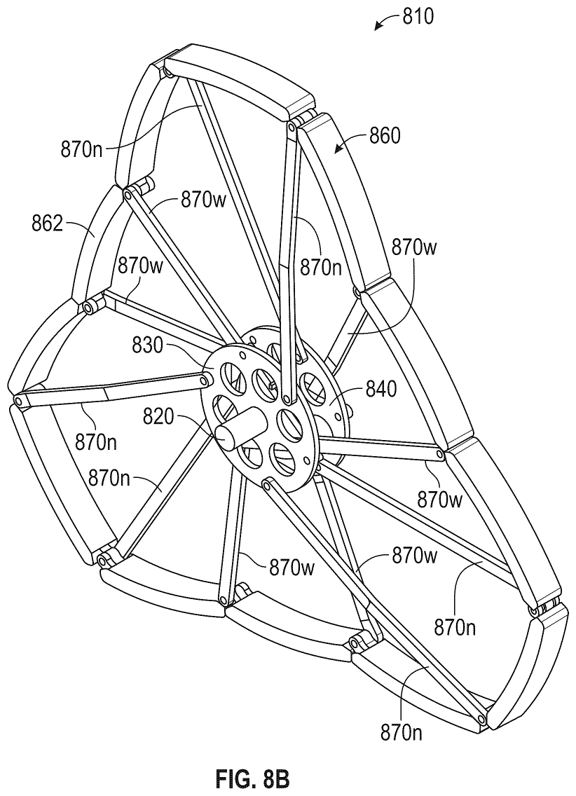

FIG. 7 illustrates an overlay of a circular shape 700 and different rounded polygonal shapes for different node designs. The two-node design has an elliptical shape 710, the three-node design has a triangular shape 720, the six-node design has a hexagonal shape 730, and the nine-node design has a nonagonal shape 740. Although not shown, a four-node design has a square shape, a five-node design has a pentagonal shape, a seven-node design has a heptagonal shape, and an eight-node design has an octagonal shape. Note that each polygonal shape 710, 720, 730 and 740 has the same perimeter as the circular shape 700.

FIG. 7 also illustrates a comparison of suspension drops for different node designs. The elliptical shape 710 has the greatest drop 4, and the suspension drop becomes smaller as the number of nodes increases.

The three node design is not limited to two hubs, and the two node design is not limited to four hubs. The number of hubs depends on considerations such as rim width. A wider rim is more susceptible to twisting out of plane.

Additional hubs would allow additional struts to be added to provide a more uniform force distribution on wider rims and provide greater support against rim twisting. For instance, the wheel 110 of FIG. 1A may be modified to have a very wide rim, a pair of hubs added to the outsides of the axle 120, and the number of struts doubled.

A wheel herein is not limited to hubs having the shape illustrated in FIG. 1A or the shape illustrated in FIG. 5. For instance, the hubs may have circular shapes.

Although FIGS. 1, 4 and 5 show wheels 110, 410 and 510 having struts 170, 470 and 570 of equal length, a wheel herein is not so limited. A wheel herein may have struts of different lengths. Struts of shorter length would be pivotably connected to arms of longer length, and struts of longer length would be pivotably connected to arms of shorter length.

FIGS. 2A and 6A show struts 170 and 570 that are roughly perpendicular to their connected arms when no operational loading is applied to the wheels 110 and 510 and the rims 160 and 560 are circular. The perpendicularity is preferred, as maximum force is initially applied along the longitudinal axes of the struts 170 and 570. However, the struts are not limited to perpendicularity. Moreover, as the operational loading is applied to the wheels 110 and 510, the struts 170 and 570 will rotate through a range of angles. For example, the struts 570 of FIG. 5 will rotate through a range of angles from roughly 30 degrees to 180 degrees.

A wheel herein is not limited to a rim that is continuous and flexible. In general, a wheel herein has a rim that is shape-adaptable. The flexible rim is one example of a shape-adaptable rim. Another example is a rim that is segmented.

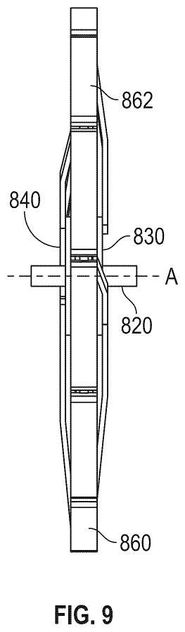

Reference is now made to FIGS. 8A, 9 and 10, which show a wheel 810 having a segmented rim 860. The wheel 810 includes an axle 820, which defines an axis A of rotation. The wheel 810 further includes first and second hubs 830 and 840 configured to be independently rotatable about the axle 820. Each hub 830 and 840 has the shape of a disc.

In FIG. 10, a portion of the first hub 830 is removed to expose a torsion spring 850. The axle 820 extends through the torsion spring 850, a first end of the torsion spring 850 is secured to the first hub 830, and a second end of the torsion spring 850 is secured to the second hub 840.

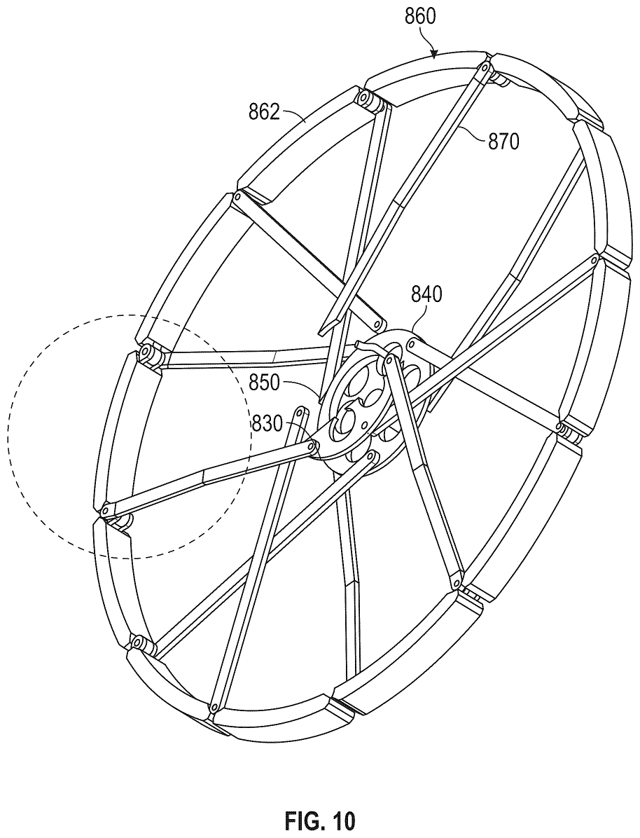

Additional reference is made to FIG. 11. The segmented rim 860 includes a plurality of rim segments 862. Each rim segment 862 has a solid arcuate body 864 with hinge rings 866 and 868 at opposite ends. The hinge rings 866 of each rim segment 862 mate with the hinge rings 868 of an adjacent segment 862.

The wheel 810 further includes twelve rigid struts 870 extending from the hubs 830 and 840 to the rim 860. A distal end of each strut 870 has a pin hole 872. The pin hole 872 is aligned with the holes in the mated rings 866 and 868, and a pin 869 is inserted through the aligned holes. Thus, not only do the adjacent rim segments 862 hinge about a pivot point, but the second end of the strut 870 also hinges about that pivot point.

A first end of the strut 870 has a pin hole for receiving a pin that is secured to the hub 830 or 840. In this manner, the struts 870 are pivotably connected to the hubs 830 and 840.

The wheel 810 has a three node design. A first group of six struts 870n is pinned to the rim 860 at node positions, and a second group of six struts 870w is pinned to the rim 860 at mid-wall positions (indices n and w refer to node and wall, respectively). Crossing struts can be offset from the hubs 830 and 840 by spacers. When an operational loading is not being applied to the axle 820, each strut 870 is roughly tangent to its hub 830 or 840, and the rim 860 has a circular shape.

Additional reference is now made to FIG. 8B. When a downward force is applied to the axle 820, the hubs 830 and 840 counter-rotate, the first group of six struts 870n pushes against the rim 860 to form the nodes, and the second group of six struts 870w pulls on the rim 860 to form the walls, resulting in the rim 860 having a rounded triangular shape 880 and a large contact patch 890 on the ground.

A wheel herein is not limited to a torsion spring between hubs. A means other than a torsion spring may be used to restrict relative rotation of the first and second hubs. For instance, rotational forces between the hubs may be impeded by a hydraulic circuit that forces hydraulic fluid to flow through a restricting orifice.

An outer surface of the rim 860 may be covered or uncovered. For instance, a rim may be covered with rubber tread.

A wheel herein is not limited to any particular vehicle Examples of vehicles include, without limitation, tractors, cars, bicycles, wheelchairs and scooters.

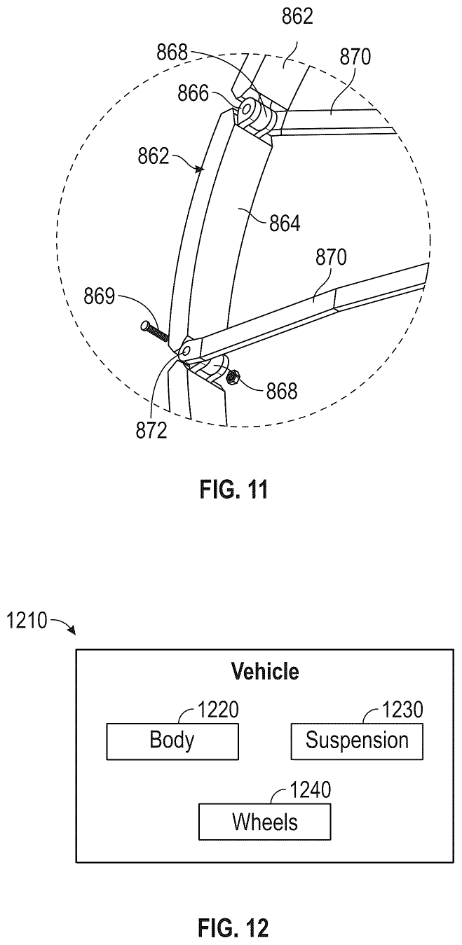

Reference is made to FIG. 12, which is a block illustration of a vehicle 1210. The vehicle 1210 includes a body 1220, optional suspension 1230 for supporting the body 1220, and a set of wheels 1240 as described herein. The wheels 1240 may be coupled directly to the body 1220 or indirectly via the suspension 1230. The number of wheels 1240 and the wheel design for the vehicle 1210 will depend upon size and weight of the vehicle 1210, terrain over which the vehicle 1210 will be operated, etc.

The wheels 1240 eliminate the need for pneumatic tires. The elimination of pneumatic items makes the wheels 1240 lighter, stronger, puncture proof and much simpler to manufacture.

The wheels 1240 have the ability to fold in suspension and shock features into the wheels 1240. In some embodiments, the suspension may be eliminated.

With or without the suspension 1230, the wheels 1240 provide weight and space saving design options.

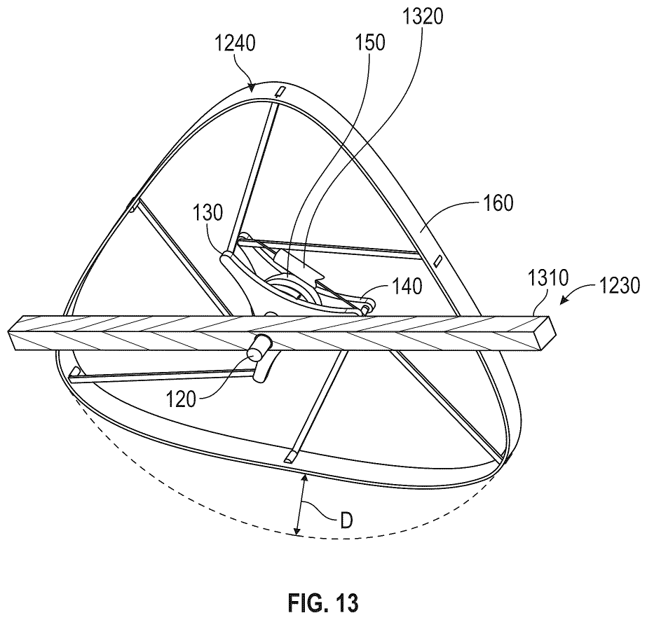

Additional reference is now made to FIG. 13, which illustrates a portion of an automotive suspension 1230 and, by way of example only, a wheel 1240 having the three-node, six strut design of FIG. 1. The wheel 1240 is mounted to a frame 1310. For instance, the axle 120 of the wheel 1240 is solidly mounted to the frame 1310. The hubs 130 and 140 pivot independently on the axle 120. Rear wheels 1240 are driven via a differential. Even when the rear wheels 1240 are turning at different rates as the vehicle 1210 is taking a turn, both rear wheels 1240 maintain their contact patches.

Because each wheel 1240 also provides shock absorption as the rim 160 collapses into its compressed shape in response to forces from any direction acting toward the axle 120, the suspension springs may be eliminated or made smaller than springs of conventional suspension systems.

Each wheel 1240 has a suspension limit D. If a wheel 1240 hits a speed bump or other bump in a road, the resulting shock will cause rim flexure as well as a torsion spring force to be applied to the axle 120. If the suspension limit D is not exceeded, the axle 120 will not rise, and no force will be transmitted to the body 1220.

The suspension 1230 may further include a shock absorber 1320 coupled between the arms of the first and second hubs 130 and 140. The shock absorber 1320 damps spring oscillations.

For vehicles 1210 such as tractors, the wheels 1240 can be smaller than a conventional wheel and pneumatic tire, and yet provide a larger contact patch. This provides the additional benefit of lowering the height of such vehicles. For example, a tractor equipped with two wheels 1240 at the rear will have advantages when loading/unloading, or when going into space-constrained storage, or when trying to roll under a fixed bridge.

The wheels 1240 provide increased mobility over rough terrain with suspension and shock built in. This is particularly valuable for vehicles such as wheelchairs and bicycles.

A wheel herein is not even limited to vehicles. Other uses include conveyors and transmissions. Conveyors could natively have shocks built in.

Transmissions could employ the constant perimeter feature of a wheel that can vary the diameter where tension is applied. Consider a bicycle pedal crank and derailleur setup that moves the chain from one gear ring to another while managing slack. This mechanism could be replaced by a front and rear flex rim wheel where a light weight cable is wrapped around the crank such that slack is not needed to be created as the front and rear components change shape. As explained above, with regard to FIG. 7, the various shapes of the rim have the same perimeter. As such, no slack in the cable is created. This would be a continuously variable transmission.

Example 1 may include wheel having an axis of rotation, the wheel comprising: at least two hubs along the axis of rotation, each hub independently rotatable about the axis; a shape-adaptable rim; and a plurality of rigid struts extending outward from the hubs to the rim, each strut having a first end pivotably connected to one of the hubs and a second end pivotably connected to the rim.

Alternatively and/or additionally, Example 2 comprises Example 1 wherein the axis of rotation is normal to a plane of rotation, and wherein the struts pivot along axes that are also normal to the plane of rotation.

Alternatively and/or additionally, Example 3 comprises one or more of Examples 1-2 wherein the hubs and struts are configured to cause a counter-rotation of the hubs when an operational load is applied to the hubs.

Alternatively and/or additionally, Example 4 comprises one or more of Examples 1-3, wherein the struts are attached to the hubs to form at least one off-center pivot on each hub to cause the counter-rotation.

Alternatively and/or additionally, Example 5 comprises one or more of Examples 1-4, wherein the counter-rotation causes a first group of the struts to push on the rim to form nodes and causes a second group of the struts to pull on the rim to form sides, resulting in the rim adapting to a rounded polygonal shape.

Alternatively and/or additionally, Example 6 comprises one or more of Examples 1-5, wherein the rounded polygonal shape includes a rolling flat spot during rotation of the rim.

Alternatively and/or additionally, Example 7 comprises one or more of Examples 1-6, wherein the wheel has a three node design.

Alternatively and/or additionally, Example 8 comprises one or more of Examples 1-7, wherein the rim has a circular shape in the absence of operational loading on the wheel, and each strut is roughly normal to a line extending radially from the axis of rotation through a pivot axis at the first end.

Alternatively and/or additionally, Example 9 comprises one or more of Examples 1-8, further comprising a means for resisting relative rotation of the hubs.

Alternatively and/or additionally, Example 10 comprises one or more of Examples 1-9, further comprising a torsion spring coupled between the hubs.

Alternatively and/or additionally, Example 11 comprises one or more of Examples 1-10, wherein the at least two hubs include first and second hubs; wherein a first group of the struts is pivotably connected to the first hub and a second group of the struts is pivotably connected to the second hub; wherein counter-rotation of the first and second hubs causes the first group of struts to push against the rim to form nodes and the second group of struts to pull on the rim to form rounded walls; and wherein the struts of the first group include one strut for each of the nodes.

Alternatively and/or additionally, Example 12 comprises one or more of Examples 1-11, wherein the rim is flexible and continuous.

Alternatively and/or additionally, Example 13 comprises one or more of Examples 1-12, wherein the rim includes a plurality of arcuate segments, where ends of adjacent segments are hinged at pivot points, and wherein the second ends of the struts are also hinged at the pivot points.

Example 14 may include a method for a wheel having a shape-adaptable rim and a plurality of struts pivotably attached to the rim, the method comprising: pushing on a first group of the struts to form nodes of a rounded polygonal shape; and pulling on a second group of the struts to form sides of the rounded polygonal shape.

Alternatively and/or additionally, Example 15 comprises Example 14, wherein counter-rotating hubs of the wheel are used to push the first group of struts and pull the second group of struts.

Alternatively and/or additionally, Example 16 comprises one or more of Examples 14-15, wherein a first one of the counter-rotating hubs pushes the first group of struts and pulls at least some struts from the second group of struts.

Example 17 may include a vehicle comprising: a body; and at least two wheels coupled to the body, each wheel including: at least two hubs along an axis of rotation, each hub independently rotatable about the axis, a shape-adaptable rim, and a plurality of rigid struts extending outward from the hubs to the rim, each strut having a first end pivotably connected to one of the hubs and a second end pivotably connected to the rim.

Alternatively and/or additionally, Example 18 comprises Example 17, wherein each wheel further includes a torsion spring coupled between the hubs.

Alternatively and/or additionally, Example 19 comprises one or more of Examples 17-18, wherein each wheel further includes an axle that defines the axis of rotation, the hubs mounted for rotation about the axle.

Alternatively and/or additionally, Example 20 comprises one or more of Examples 17-19, wherein the rim of each wheel is flexible and continuous.

Alternatively and/or additionally, Example 21 comprises one or more of Examples 17-20, wherein the rim of each wheel includes a plurality of arcuate segments, where ends of adjacent segments are hinged at pivot points, and wherein the second ends of the struts are also hinged at the pivot points.

Alternatively and/or additionally, Example 22 comprises one or more of Examples 17-21, further comprising a suspension system for supporting the body, wherein the at least two wheels are coupled to the suspension system.

Alternatively and/or additionally, Example 23 comprises one or more of Examples 17-22, wherein the at least two hubs include first and second hubs; and wherein the vehicle further comprises a shock absorber coupled between arms of the first and second hubs.

The descriptions of the various embodiments herein have been presented for purposes of illustration and are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A wheel having an axis of rotation, the wheel comprising:
at least two hubs along the axis of rotation, each hub independently rotatable about the axis;
a shape-adaptable rim; and
a plurality of rigid struts extending outward from the hubs to the rim, each strut having a first end pivotably connected to one of the hubs and a second end pivotably connected to the rim.

2. The wheel of claim 1 wherein the axis of rotation is normal to a plane of rotation, and wherein the struts pivot along axes that are also normal to the plane of rotation.

3. The wheel of claim 1, wherein the hubs and struts are configured to cause a counter-rotation of the hubs when an operational load is applied to the hubs.

4. The wheel of claim 3, wherein the struts are attached to the hubs to form at least one off-center pivot on each hub to cause the counter-rotation.

5. The wheel of claim 3, wherein the counter-rotation causes a first group of the struts to push on the rim to form nodes and causes a second group of the struts to pull on the rim to form sides, resulting in the rim adapting to a rounded polygonal shape.

6. The wheel of claim 5, wherein the rounded polygonal shape includes a rolling flat spot during rotation of the rim.

7. The wheel of claim 5, wherein the wheel has a three node design.

8. The wheel of claim 3, wherein the rim has a circular shape in the absence of operational loading on the wheel, and each strut is roughly normal to a line extending radially from the axis of rotation through a pivot axis at the first end.

9. The wheel of claim 1, further comprising a means for resisting relative rotation of the hubs.

10. The wheel of claim 1, further comprising a torsion spring coupled between the hubs.

11. The wheel of claim 1, wherein the at least two hubs include first and second hubs; wherein a first group of the struts is pivotably connected to the first hub and a second group of the struts is pivotably connected to the second hub; wherein counter-rotation of the first and second hubs causes the first group of struts to push against the rim to form nodes and the second group of struts to pull on the rim to form rounded walls; and wherein the struts of the first group include one strut for each of the nodes.

12. The wheel of claim 1, wherein the rim is flexible and continuous.

13. The wheel of claim 1, wherein the rim includes a plurality of arcuate segments, where ends of adjacent segments are hinged at pivot points, and wherein the second ends of the struts are also hinged at the pivot points.

14. A method for a wheel having a shape-adaptable rim and a plurality of struts pivotably attached to the rim, the method comprising:
pushing on a first group of the struts to form nodes of a rounded polygonal shape; and
pulling on a second group of the struts to form sides of the rounded polygonal shape.

15. The method of claim 14, wherein counter-rotating hubs of the wheel are used to push the first group of struts and pull the second group of struts.

16. The method of claim 15, wherein a first one of the counter-rotating hubs pushes the first group of struts and pulls at least some struts from the second group of struts.

17. A vehicle comprising:
a body; and
at least two wheels coupled to the body, each wheel including:
at least two hubs along an axis of rotation, each hub independently rotatable about the axis,
a shape-adaptable rim, and
a plurality of rigid struts extending outward from the hubs to the rim, each strut having a first end pivotably connected to one of the hubs and a second end pivotably connected to the rim.

18. (canceled)

19. The vehicle of claim 17, wherein each wheel further includes an axle that defines the axis of rotation, the hubs mounted for rotation about the axle.

20. (canceled)

21. (canceled)

22. The vehicle of claim 17, further comprising a suspension system for supporting the body, wherein the at least two wheels are coupled to the suspension system.

23. The vehicle of claim 22, wherein the at least two hubs include first and second hubs; and wherein the vehicle further comprises a shock absorber coupled between arms of the first and second hubs.
